(19) United States
(12) Patent Application Publication
(10) Pub. No.: US 2007/0291105 A1
(43) Pub. Date: Dec. 20, 2007

(54) Methods of remotely presenting and selling visual media to a person during an oral communication session with such person

(75) Inventor: Renato Cataldo, St. Louis, MO (US)

Correspondence Address: THOMPSON COBURN, LLP, ONE US BANK PLAZA, SUITE 3500, ST LOUIS, MO, 63101, US

(73) Assignee: CPI Corp

(21) Appl. No.: 11/454,223

(22) Filed: Jun. 16, 2006

(51) Int. Cl. H04N 7/14

(52) U.S. Cl. 348/14.01

(57) ABSTRACT

A method of remotely presenting and selling visual media to a customer comprises steps of participating in a remote oral communication session with the customer and altering at least a portion of what the customer is able to view on a visual display device during the oral communication session. The visual media preferably comprises images of persons or pets that are familiar to the customer.

### FIELD OF THE INVENTION

This invention is directed primarily to the portrait industry. More particularly, this invention is directed to methods of remotely conducting orally assisted sales of visual media.

Various methods of conducting business exist in the portrait industry. Such methods include the traditional method of taking photographs of one or more persons in a studio and thereafter displaying a plurality of prints of such photographs in-person to a customer to allow the customer to select particular prints for purchase. Some portrait industry business methods comprise steps of editing and enhancing some or all of the original photographs. Additionally, some methods comprises steps of making images available for viewing on a website and allowing the customer to select and purchase particular images therefrom, without personal assistance.

However, despite the advantages of various portrait industry business methods, most of the prior art methods have some disadvantages. For example, portrait industry business methods that do not include providing personal assistance to customers when such customers are in the process of selecting images for purchase tend to have less sales than would likely occur if personal assistance was providing during the sale and selection process. However, business methods wherein in-person personal assistance is provided to customers tend to be more costly and time consuming. This is because the time spent editing images and assisting customers in the selection process in significant. As a result, such steps can become a bottleneck in the operation of portrait studio.

### SUMMARY OF THE INVENTION

The present invention overcomes many of the disadvantages associated with prior business methods used in the portrait studio industry. In one aspect of the invention, a method comprises a step of participating in an oral communication session with a person. The oral communication session is a remote communication session and occurs through an oral communication system. The person is able to view a visual display device during the oral communication session. The method further comprises a step of making a first visual media file accessible for the person to view on the visual display device via a data network during the oral communication session. Furthermore, the method comprises a step of making a second visual media file accessible for the person to view on the visual display device via the data network during the oral communication session. The first visual media file is inaccessible to the person for display on the visual display device while the second visual media file is being made accessible for the person to view on the visual display device. Still further, the method comprises a step of selling visual media to the person. The visual media is dependent upon at least one of the first and second visual media files. The selling comprises orally discussing payment options with the person during the oral communication session.

In another aspect of the invention, a method comprises a step of obtaining a plurality of photographic images of at least one subject. The method also comprises a step of participating in an oral communication session with a person. The oral communication session is a remote communication session that occurs through an oral communication system. The person is able to view a visual display device during the oral communication session. The method further comprises a step of making a first image accessible for the person to view on the visual display device via a data network during the oral communication session. The first image is dependent upon a first digital file that has been at least partially obtained from at least one of the photographic images. Furthermore, the method comprises a step of creating a second digital file using the first digital file in response to oral communications provided by the person during the oral communication session. Still further, the method comprises making a second image accessible for the person to view on the visual display device via the data network during the oral communication session. The second image is dependent upon the second digital file.

In yet another aspect of the invention, a method comprises a step of obtaining a plurality of photographic images of at least one subject. The method also comprises a step of participating in an oral communication session with a person. The oral communication session is a remote communication session that occurs through an oral communication system. The first person is able to view a visual display device during the oral communication session. Furthermore, the method comprises a step of making an image accessible for the person to view on the visual display device via a data network during the oral communication session. The image is dependent upon a digital file that has been at least partially obtained from at least one of the photographic images. Still further, the method comprises a step of selling an item to the person. The item can be either a digital file or a photographic print generated from the digital file.

In yet another aspect of the invention, a method comprises steps of obtaining a plurality of photographic images of at least a first person, and participating in an oral communication session with at least one of the first person and a second person. The second person is related to the first person. The oral communication session is a remote communication session occurring through an oral communication system. The one of the first and second persons is able to view a visual display device during the oral communication session. The method also comprises a step of presenting a plurality of digital images on the visual display device via a data network during the oral communication session. The presenting comprises remotely altering what is displayed on the visual display device in response to oral communications made by the one of the first and second persons. Furthermore, the method comprises a step of selling an item to the one of the first and second persons. The item can be either a digital image file that is dependent upon at least one of the photographic images, or a photographic print that is dependent upon at least one of the photographic images.

While the principal advantages and features of the invention have been described above, a more complete and thorough understanding of the invention may be obtained by referring to the drawing figure and the detailed description of the preferred embodiment, which follow.

### BRIEF DESCRIPTION OF THE DRAWING FIGURE

FIG. 1 is flow diagram of the preferred method of practicing the invention.

Reference numerals in the written specification and in the drawing figure indicate corresponding items or steps.

### DETAILED DESCRIPTION OF THE PREFERRED EMBODIMENT OF THE INVENTION

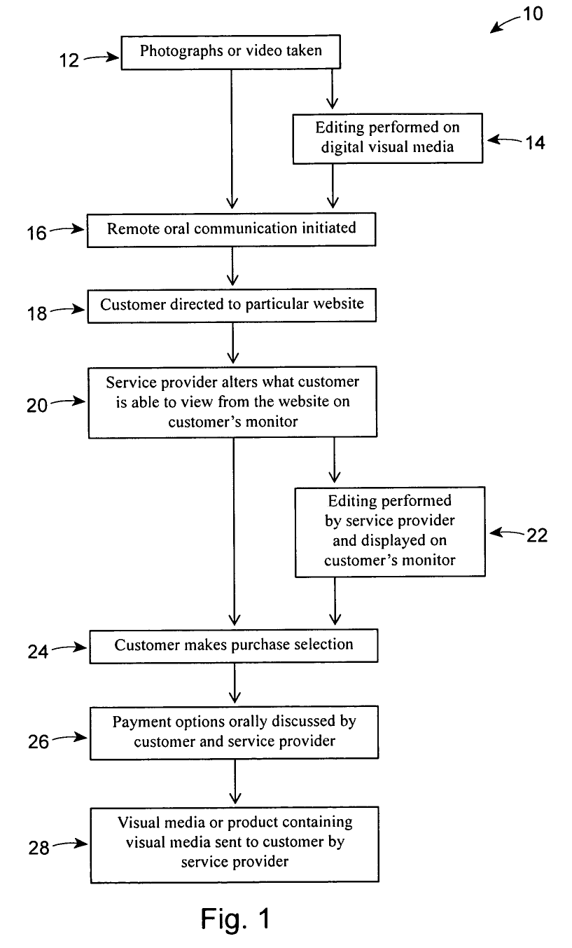

A preferred embodiment of a method 10 in accordance with the invention the flow diagram of FIG. 1. The method 10 comprises several main steps, and other optional steps. In general, the method 10 begins with a step of obtaining photographs or video media of a subject. This step is indicated in the drawing figure by reference numeral 12. The photographs or video media are preferably photographs or video taken by a professional photographer or video artist in a studio. More preferably, the professional photographer or video artist is employed by or hired by the entity performing the method 10. The subject is preferably a person or a pet. It should appreciated however that the photographs or video media need not be taken or created under the control of the entity performing the method 10, but that the entity performing the method nonetheless obtains the photographs or video media. For convenience, the entity performing the method 10 is referred to hereafter as the “service provider.”

If the visual media is not in a digital format when obtained, the visual media is preferably converted to a digital format by the service provider. Referring to step indicated by reference numeral 14, the service provider may edit the visual media any time after the visual media has been obtained. Preferably, at least initial editing is performed by the service provider prior to performing the steps discussed below. The editing may include such things as cropping images, enhancing the visual media, applying filters, and manually altering images via software programs such as Photoshop® made by Adobe Systems Incorporated. The service provider may also make a determination as to which photographs or what portions of video are best suited for presentation and may prepare a presentation therefrom.

Referring to step indicated by reference numeral 16, the method 10 comprises a step wherein the service provider participates in a remote oral communication with a person. This person, hereafter referred to as “the customer,” may be a person whose image appears in the visual media, a person related (by blood, marriage, adoption, or a sequence thereof) to another person whose image appears in the visual media, or even a person with no connection to the subject appearing in the visual media. Preferably, the oral communication is initiated by the service provider and occurs at a time previously agreed to by the service provider and the customer. More preferably, the time is arranged at a studio where the photographs or videos were taken. The remote oral communication preferably occurs via a telephone communication system or a voice over Internet protocol (VOIP) system, but can occur through any form of oral communication network. Preferably the customer is at his or her residence or place of work during the oral communication session.

During the oral communication session, the service provider preferably directs the customer to a particular uniform resource locator (URL) address or site on the Internet (as is indicated by reference numeral 18 in FIG. 1). The customer then connects to the URL site via a data network such as a digital subscriber line, cable service, or wireless fidelity system. The service provider preferably has control over the content of what can be viewed on the URL site using software that facilitates remote presentations via the Internet. Such software is provided by companies such as such as Glance Networks, Inc. and GatherWorks Inc. From the URL site, the customer is able to view a presentation made by the service provider using any visual display device such as a computer monitor, a television, a mobile phone, or a mobile internet access device such as a BlackBerry® while also orally communicating with the service provider. Preferably, the service provider makes various visual media files available for display via the URL site. The visual media files are preferably modified versions of photographs or video content that are based upon the photographs or videos that were previously edited. More specifically, the visual media files displayed are preferably lower resolution versions of visual media files under the control of the service provider. Additionally, as indicated in FIG. 1 by reference numeral 20, the service provider preferably makes particular visual media files available for display, and removes other visual media files from display, during the oral communication session. Thus, the service provider is able to identify which visual media files the customer finds appealing and can eliminate those others from selection based on oral communications provided by the customer.

Optionally, as is indicated in FIG. 1 reference numeral 22, the service provider can edit one or more visual media files to suit the preferences of the customer based on communications provided by the customer and make additional visual media files available for display via at the URL site which are dependent upon the edited visual media files. For example, the customer may orally request that the background of a static image be lightened and the foreground darkened. In this example, the service provider could create a new visual media file or alter a existing visual media file using editing software such as PhotoShop® and then make such modified or new image, or a lower resolution version thereof, available for viewing via the URL site.

During the oral communication session, the service provider preferably orally discuses various purchase options with the customer. The purchase options may include various package deals involving the purchase of one or more tangible copies of high resolution images or videos and visual media files upon which the viewed visual media files depended. The purchase options may also involve items bearing images derived from viewed visual media files. Additionally, the purchase options may also include various payment options such as purchase by credit card, the Internet, or check. Still further, the purchase options may also include the customer orally providing payment information such as a credit card number or the like to the service provider. These steps are indicated in FIG. 1 by reference numerals 24 and 26.

After completing a purchase transaction or request, the oral communication session is terminated by either the service provider or the customer. If a purchase agreement is made, the service provider provides the purchased items to the customer. The purchased items may be tangible visual media such as photographic prints, videos on disk or magnetic tape, or other items bearing visual media, such as a coffee cup or a tee-shirt having images displayed thereon. Such types of items are preferably mailed by the service provider to the customer or are made available for pick-up to the customer by the service provider. The purchased items may also be digital media files recorded on digital storage devices or made available for download on the URL site or other Internet sites. Preferably, the items are all dependent upon the original visual media of the subject obtained by the service provider. This step is indicated by reference numeral 28 in FIG. 1.

In view of the foregoing, it should be appreciated that the invention provides many advantages over the prior art and is useful in many industries including the portrait studio industry. For example, the invention eliminates bottlenecks that frequently occur in portrait industry. More specifically, the invention eliminates the task of presenting visual media to a customer and negotiating a purchase at a studio following a photography or video session. This increases the productivity of portrait businesses by allowing brick-and-mortar studios to merely obtain the visual media, while the sales and presentation aspect of such businesses is located off-site. The invention also benefits customers by decreasing the time a person must spend at a brick-and-mortar studio to obtain desired photographs or videos. Still further, the invention has application in businesses other than the portrait industry. For example, photographic editing companies and companies specializing in restoring old visual media can also utilize various aspects of the invention. Thus, numerous benefits and advantages of the invention should be appreciated.

While the present invention has been described in reference to a specific embodiment, in light of the foregoing, it should be understood that all matter contained in the above description or shown in the accompanying drawings is intended to be interpreted as illustrative and not in a limiting sense and that various modifications and variations of the invention may be constructed without departing from the scope of the invention defined by the following claims. Thus, other possible variations and modifications should be appreciated.

Furthermore, it should be understood that when introducing elements of the present invention in the claims or in the above description of the preferred embodiment of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed.

What is claimed is:

1. A method comprising:
participating in an oral communication session with a person, the oral communication session being a remote communication session occurring through an oral communication system, the person being able to view a visual display device during the oral communication session;
making a first visual media file accessible for the person to view on the visual display device via a data network during the oral communication session;
making a second visual media file accessible for the person to view on the visual display device via the data network during the oral communication session, the first visual media file being inaccessible to the person for display on the visual display device while the second visual media file is being made accessible for the person to view on the visual display device; and
selling visual media to the person, the visual media being dependent upon at least one of the first and second visual media files, the selling comprising orally discussing payment options with the person during the oral communication session.

2. A method in accordance with claim 1 wherein the oral communication system is separate from the data network.

3. A method in accordance with claim 1 wherein the visual media is a photographic print.

4. A method in accordance with claim 3 wherein the photographic print comprises a visual image of the person.

5. A method in accordance with claim 1 wherein the second visual media file is dependent upon the first visual media file.

6. A method in accordance with claim 1 wherein the second visual media file is created during the oral communication session.

7. A method in accordance with claim 6 wherein the second visual media file is dependent upon the first visual media file.

8. A method in accordance with claim 1 wherein the step of selling visual media to the person further comprises orally obtaining payment information from the person during the oral communication session.

9. A method comprising:
obtaining a plurality of photographic images of at least one subject;
participating in an oral communication session with a person, the oral communication session being a remote communication session occurring through an oral communication system, the person being able to view a visual display device during the oral communication session;
making a first image accessible for the person to view on the visual display device via a data network during the oral communication session, the first image being dependent upon a first digital file that has been at least partially obtained from at least one of the photographic images;
creating a second digital file using the first digital file in response to oral communications provided by the person during the oral communication session; and
making a second image accessible for the person to view on the visual display device via the data network during the oral communication session, the second image being dependent upon the second digital file.

10. A method in accordance with claim 9 further comprising selling an item to the person, the item being one of the first digital file, the second digital file, a photographic print generated from the first digital file, and a photographic print generated from the second digital file.

11. A method in accordance with claim 10 wherein the selling comprises orally obtaining payment information from the person during the oral communication session.

12. A method in accordance with claim 9 wherein each of the photographic images comprises a visual image of the person.

13. A method in accordance with claim 9 wherein the oral communication system is separate from the data network.

14. A method in accordance with claim 9 wherein the step of making the second image accessible to view on the visual display device occurs in a manner such that the first image is inaccessible to the person for display on the visual display device while the second image is being made accessible for the person to view on the visual display device.

15. A method comprising:
obtaining a plurality of photographic images of at least one subject;
participating in an oral communication session with a person, the oral communication session being a remote communication session occurring through an oral communication system, the first person being able to view a visual display device during the oral communication session;
making an image accessible for the person to view on the visual display device via a data network during the oral communication session, the image being dependent upon a digital file that has been at least partially obtained from at least one of the photographic images; and
selling an item to the person, the item being one of the digital file and a photographic print generated from the digital file.

16. A method in accordance with claim 15 wherein the selling comprises orally obtaining payment information from the person during the oral communication session.

17. A method in accordance with claim 15 wherein the image constitutes a first image and the data file constitutes a first data file, the method further comprises a step of making a second image accessible to view on the visual display device via the data network during the oral communication session, the second image is dependent upon a second digital file that has been at least partially obtained from at least one of the photographic images, and the step of making the second image accessible to view on the visual display device occurs in a manner such that the first image is inaccessible to the person for display on the visual display device while the second image is being made accessible for the person to view on the visual display device.

18. A method in accordance with claim 17 wherein the second data file is dependent upon the first data file.

19. A method in accordance with claim 15 wherein the subject is the person.

20. A method in accordance with claim 15 wherein the oral communication system is separate from the data network.

21. A method comprising:
obtaining a plurality of photographic images of at least a first person;
participating in an oral communication session with at least one of the first person and a second person, the second person being related to the first person, the oral communication session being a remote communication session occurring through an oral communication system, the one of the first and second persons being able to view a visual display device during the oral communication session;
presenting a plurality of digital images on the visual display device via a data network during the oral communication session, the presenting comprising remotely altering what is displayed on the visual display device in response to oral communications made by the one of the first and second persons;
selling an item to the one of the first and second persons, the item being one of a digital image file that is dependent upon at least one of the photographic images and a photographic print that is dependent upon at least one of the photographic images.
